(19) United States
(12) Patent Application Publication
(10) Pub. No.: US 2005/0075980 A1
(43) Pub. Date: Apr. 7, 2005

(54) Check Assurance Protection System

(76) Inventor: Ralph G Fontana, Winter Park, FL (US)

Correspondence Address: JEFFREY FURR, 253 N. MAIN STREET, JOHNSTOWN, OH, 43031, US

(21) Appl. No.: 10/605,536

(22) Filed: Oct. 6, 2003

(51) Int. Cl. G06F 17/60

(52) U.S. Cl. 705/43; 705/42

(57) ABSTRACT

The current invention is a check handling process and system. The system, via electronic debit, receives a merchant's bad checks, via mail from the merchant or the merchant's bank, and then scans them and collects them through the Federal Reserve and the Automated Clearing House (ACH). The system will receive the face value of the check, plus any fees that are allowed by state law. Once the system has collected the face value of the check and fee, the system will pay the merchant for the check only. Thus, the merchant is able to recover a large portion of their bad checks without it costing them any money. The check writers pay the fees collected by the system.

### BACKGROUND OF INVENTION

1. Field of the Invention

The present invention relates to a check system and, more particularly, to a check system dealing with returned checks.

2. Description of Prior Art

No one is sure when the first check was written. Some experts think the Romans may have invented the check about 352 BC. Even if that were true, the idea apparently didn't catch on. Banks or bank-like institutions existed in ancient Mesopotamia, Greece, and Rome, and probably transferred deposits from one account to another, but no documentary evidence of such transfers has survived.

The earliest evidence of deposits subject to “cheque” dates to medieval Italy and Catalonia. In the primitive banks of deposits in those areas it was necessary for the depositor to appear in person before a banker either to withdraw funds or to transfer them to an account of another customer. The use of written instruments for those purposes gradually evolved.

It is believed that it probably wasn't until the early 1500s, in Holland, that the check first got widespread usage. Amsterdam in the sixteenth century was a major international shipping and trading center. People who had accumulated cash began depositing it with Dutch “cashiers,” for a fee, as a safer alternative to keeping the money at home. Eventually the cashiers agreed to pay their depositors' debts out of the money in each account, based on the depositor's written order or “note” to do so.

The first printed checks are traced to British banker Lawrence Childs in 1762. The word “check” probably originated in England in the 1700s when serial numbers were placed on these pieces of paper as a way to keep track of them.

As checks became more widely accepted, bankers discovered that there was a big problem with collecting the money due from so many other banks. At first, each bank sent people to the other banks to present checks for collection, but that meant a lot of traveling and a lot of cash being hauled around. The solution to this problem was found in the 1700s, when a system of check “clearing-houses” networks of banks that exchange checks with each other was formed. Today banks in the U.S. can present checks to the Federal Reserve System or private clearing-houses for regional and national check collection.

In the United States, checks are said to have first been used in 1681 when cash-strapped businessmen in Boston mortgaged their land to a “fund”, against which they could write checks.

During the check clearing process, checks pass through large sorting equipment that reads the magnetic ink characters (MICR) at the bottom of the check and places the check in sorting “pockets”. The MICR standard, developed in the US by a consensus group of banks and technology in the 1950s, provided tremendous improvements to the check payment process by enabling the automation of many check handling procedures. It contains information such as the routing number identifying the drawee bank, the payment amount, and the customer account number of the payor. The payee's bank is then credited for the payment amount, and it transfers these funds to the payee's account.

The check is then physically transported to the drawee's bank and presented to the drawee's bank by the clearing institution where the payment amount is debited from the payor's bank associated with the customer account number.

At present day, there are approximately 70 billion checks written by consumers, businesses, and government entities. This is at a cost of about 1% of the US Gross Domestic Product. It is estimated that check fraud losses are over $53 billion annually with banks writing-off $1.34 billion and retailers and other payees absorbing $52 billion. It is predicted that check fraud will continue to grow over the next 12 years by 12 to 15 percent annually.

Overdrafts are the amount by which withdrawals exceed deposits with Overdraft Protection being a service that allows the customer to write checks for an amount over and above the amount in their checking account. Funds are transferred from their line of credit or other designated account to their checking account as needed. This service must be applied for and approved. A check or demand instrument that causes an overdraft can be referred to an NSF (non sufficient funds) item.

There exists a need for a better method and system to recover funds from people overdrafting funds, while reducing the costs. There is still need for improvement in the art.

### SUMMARY OF INVENTION

The current invention is a check handling process and system. The system, via electronic debit, receives a merchant's bad checks, via mail from the merchant or the merchant's bank, and then scans them and collects them through the Federal Reserve and the Automated Clearing House (ACH).

In the preferred embodiment, the system will receive the face value of the check, plus any fees that are allowed by state law. Once the system has collected the face value of the check and fee, the system will pay the merchant for the check only. Thus, the merchant is able to recover a large portion of their bad checks without it costing them any money. The check writers pay the fees collected by the system One objective of the current invention is to provide a merchant with a system to receive payment for bad check without cost to the merchant.

Another objective is for a system where it is easier for a merchant to receive payment for bad checks.

To accomplish the above and related objectives, this invention may be embodied in the form illustrated in the accompanying drawings, attention being called to the fact, however, that the drawings are illustrative only, and that changes may be made in the specific structure illustrated.

Definitions:

ACH—Automated Clearing House.

Acknowledgment—An answer or response in return for something done.

Centralized Returns—When an endorser endorses the back of his/her check, the endorsement stamp states to the Clearing Operation at the Federal Reserve Bank to “Return this Item to Centralized Returns, Blah Blah Bank, New York. Directing to the Federal Reserve Bank where to return the item.

Clearing—The process a check goes through to validate and transfer funds between banks.

Clearinghouses—Networks of banks that exchange checks with each other.

Decrypt Decryption—The act of unscrambling a message to enable reading the contents.

Duplicate Detection—A bank process of identifying duplicate checks that have been sent to the bank for deposit.

Internet—The Internet is the world's largest computer network. It allows any computer on the network to communicate with any other computer on the network.

MICR—magnetic ink characters that contains information such as the routing number identifying the drawee bank, the payment amount, and the customer account number of the payor.

NSF—Non sufficient funds in an account to cover the money drawn from the account.

Overdrafts—The amount by which withdrawals exceed deposits.

Overdraft Protection A service that allows the customer to write checks for an amount over and above the amount in their checking account. Funds are transferred from their line of credit or other designated account to their checking account as needed. This service must be applied for and approved.

### BRIEF DESCRIPTION OF DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows a normal flow of an NSF check;

FIG. 2 shows a flow of a Consolidated Returns Check;

FIG. 3 shows a Processing Diagram; and

FIG. 4 displays a sample process for a pizzeria.

### DETAILED DESCRIPTION

The current invention is a check handling process and system. The system, via electronic debit, receives a merchant's bad checks, via mail from the merchant or the merchant's bank, and then scans them and collects them through the Federal Reserve and the Automated Clearing House (ACH).

In the preferred embodiment, the system will receive the face value of the check, plus any fees that are allowed by state law. Once the system has collected the face value of the check and fee, the system will pay the merchant for the check only. Thus, the merchant is able to recover a large portion of their bad checks without it costing them any money. The check writers pay the fees collected by the system

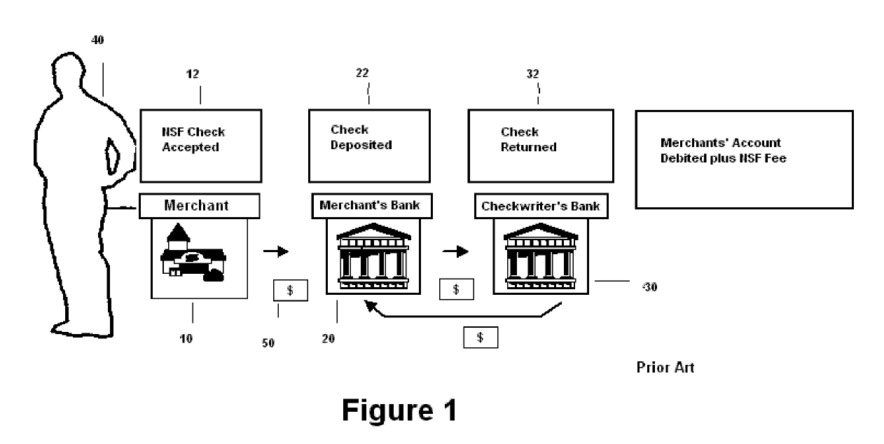

FIG. 1 displays the normal flow of an NSF (not sufficient funds) check. A check or demand instrument 50 that causes an overdraft can be referred to an NSF (non sufficient funds) item. In step 12, a merchant 10 deposits a $50 check 50 into their account. The merchant's bank 20 sends the $50 check to the check writer's 40 bank 30, step 22. The check writer's 40 bank 30, returns the check 50 back to the merchant's bank 20, step 32. The merchant's bank 20 then debits the merchant 10 for the $50 for the returned check 50 plus a return check fee, which in this example it $5.

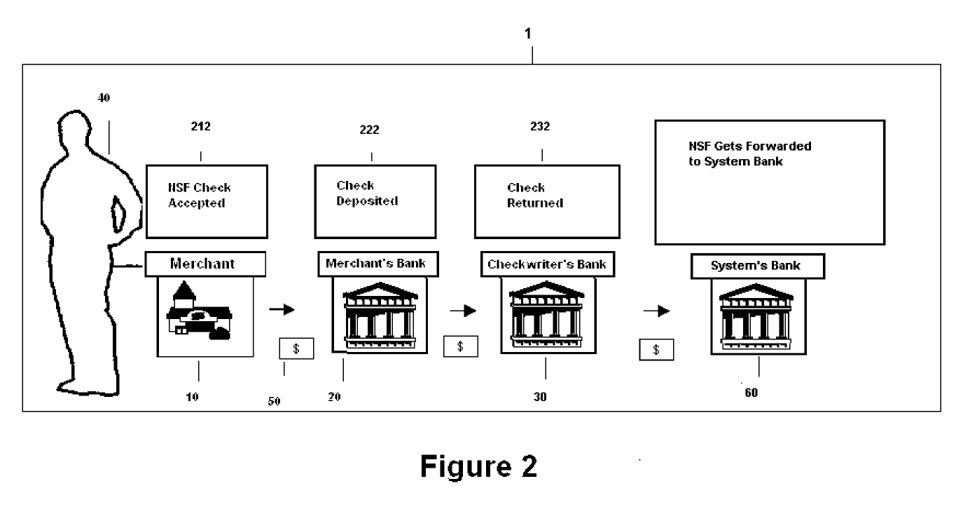

FIG. 2 displays the basic flow of the current invention. A check or demand instrument 50 that causes an overdraft can be referred to an NSF (non sufficient funds) item. In step 212, a merchant 10 deposits a $50 check 50 into their account. The merchant's bank 20 sends the $50 check to the check writer's 40 bank 30, step 222. The check writer's 40 bank 30, sends the check 50 to the system's 1 bank 60, step 232. The system's 1 bank 60 will debit the merchant's 10 account, the system 1 will also charge the merchant's 10 account a small consolidation fee. This consolidation fee will be less than the return check fee.

The system 1 uses the process called “Centralized Returns” wherein when the merchant 10 endorses the back of his check, the endorsement stamp states to the Clearing Operation at the Federal Reserve Bank to “Return this Item to Centralized Returns, Blah Blah Bank, New York”. When it is done this way, the clearinghouse sends the returned check 50 to the system's 1 bank 60. The benefit to the merchant 20 is that their bank 20 doesn't even see a returned item or check 50, and they avoid the normal return check fee from them.

In addition, the merchant's bank 20 thinks that the merchant 10 is a better client because none of their customers have returned items or checks 50. The system 1 has the additional benefit to the merchant that the check 50 gets into the system 1 faster (that night in the preferred embodiment) and the system 1 can proceed to collect the check 50 faster and get the money for the check 50 faster.

In the preferred embodiment, the system 1, just as in normal Electronic Recovery, will provide no guarantee that all of the checks 50 will be collected.

Instead of the merchant 10 being responsible for their customer's checks 50, the system 1 will “assure” the check. The system 1 will take control and collect the check 50 via Electronic RecoveryIn the preferred embodiment, if the merchant's 10 customer's check 50 is return for insufficient fund, it still goes to the Centralized Return Account at the system's bank 60, but instead of the system 1 debiting the merchant's account, the system 1 will debit an account established expressly for this purpose. Therefore, the system 1 will have funds in the account to even out the accounting books.

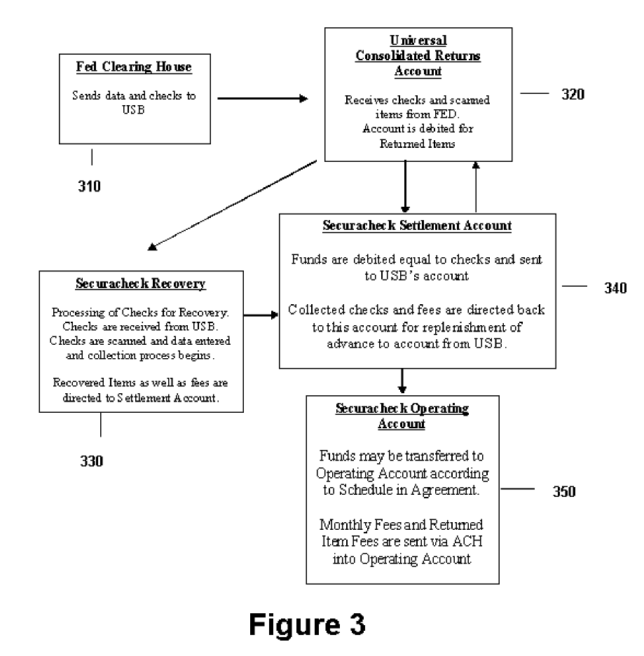

FIG. 3 displays a processing diagram. In FIG. 3 the checkwriter's bank 30 is referred to as USB (United States Bank) and the System 1 as Securacheck. The system 1 receives returned items from FED (Federal Clearinghouse) into the checkwriter's bank 30, step 310. The checkwriter's bank 30 deems the check 50 to be NSF and forwards it to the system's bank 60 for recovery, step 330. The system's 1 bank 60 receives the checks 50 and scanned items for the FED and debits the Consolidated Returns Account, Step 320. The system's bank 60 deducts the amount from the system's Settlement account, Step 320. The system 1 processes the checks 50 for recovery. Physical Checks are scanned and the first recovery attempt is made, Step 330. The face amounts and fees collected go back to the system's 1 Settlement Account to replenish any funds that have been used for the checkwriter's bank 60 Consolidated Returns account, step 340. The system 1 maintains funds according to an Agreement, step 350. Items and checks 50 not collected on the first attempt are repeated again, with the same sequence as above.

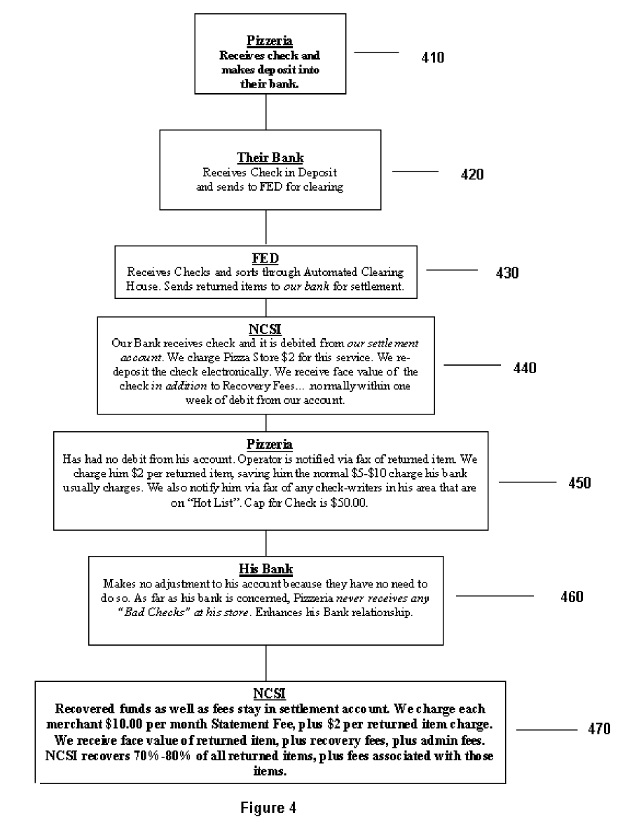

FIG. 4 gives an example of the system being used with a pizzeria. With pizzerias, Chinese Food, and Take-Out Type operators is :Average ticket, there is always a phone number required to get delivery and there is a physical address that it is delivered to by the driver. When the above items are not addressed, non-collection goes up tremendously.

In step 410, the Pizzeria receives the check 50 and makes a deposit into their bank 20. In step 420, their bank 20 receives the check in deposit and sends it to the Federal Clearinghouse for clearing. The Federal clearinghouse receives the checks 50 and sorts through Automated Clearing House (ACH) and sends returned items to the system's bank 60 for settlement, step 430. The system's bank 60 receives the check 50 and debits the amount to the system's settlement account. A fee may be charged to the merchant 20 by the system 1 for this. The system 1 will attempt to collect on the check 50 by re-depositing the check 50 electronically, step 440. The merchant 10 has had no debit from his account. The merchant 10 will receive notice from the system 1 of the returned item. This notice can be by FAX or other electronic notice such as E-mail. The system 1 will also give notice to the merchant 10 of check-writers in their area that have written NSF checks 50, step 450. The merchant's bank 20 makes no adjustment to the merchant's account as they have no notice of any NSF checks 50, step 460. The system 1 may charge a monthly statement fee plus a charge for each NSF check, step 470.

The system 1 will be written using techniques, programming languages and knowledge that is commonly known in the art.

### ALTERNATIVE EMBODIMENT

The system 1 would allow the merchant 10 to have check guarantee, which would guarantee their checks 50. This may or may not have exceptions such as fraud or stop payment or closed account. In this embodiment, the merchant 20 pays a discount fee plus a transaction fee on each check 50 presented, whether good or bad, but there is still room for them not to be paid on every check.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A process comprising the steps of:
having a person write a check to a merchant, having said merchant forward that check to the merchant's bank, having said merchant's bank forwarding said check to a clearing house, having said check being returned for insufficient funds, having said check being returned to said clearinghouse and having said clearinghouse forwarding said check to a consolidated bank.

2. A process according to claim 1 that includes the steps of having said consolidated bank collect the funds from said person.

3. A process according to claim 2 that includes the steps said system collect said funds through an electronic recovery.

4. A process according to claim 1 that includes the steps of having said system charge said merchant a consolidation fee.

5. A process according to claim 1 that includes the steps of having said merchant endorsing the back of said check specifying said consolidation bank as the return to bank.

6. A process according to claim 1 that includes the steps of having said system debit said merchant's account for said returned check.

7. A process according to claim 1 that includes the steps of having said system debit a system account for said returned check.

8. A process according to claim 1 that includes the steps of having said merchant being a restaurant.

9. A process according to claim 1 that includes the steps of notifying said merchant of said check.

10. A process according to claim 9 where said notification is done electronically.

11. A process according to claim 9 where said notification is done through the mail.

12. A process according to claim 9 where said notification is done through a facsimile.

13. A process according to claim 9 where said notification is done through the Internet.

14. A process according to claim 9 where said notification is done through an E-mail.

15. A process according to claim 1 that includes the steps of notifying said merchant of person who wrote NSF checks.

16. A process according to claim 15 where said notification is done electronically.

17. A process according to claim 15 where said notification is done through the mail.

18. A process according to claim 15 where said notification is done through a facsimile.

19. A process according to claim 15 where said notification is done through the Internet.

20. A process according to claim 1 which includes the step of having said system guarantee the payment of said check.
